(19) United States
(12) Patent Application Publication
(10) Pub. No.: US 2009/0250049 A1
(43) Pub. Date: Oct. 8, 2009

(54) Gas-Supply Regulating Device for Use in a Gas Burner Assembly

(75) Inventor: Jack Tseng, Chiayi Hsien (TW)

Correspondence Address: THE WEBB LAW FIRM, P.C., 700 KOPPERS BUILDING, 436 SEVENTH AVENUE, PITTSBURGH, PA, 15219, US

(73) Assignee: SING CHEN INTERNATIONAL CO., LTD., Chiayi Hsien (TW)

(21) Appl. No.: 12/099,507

(22) Filed: Apr. 8, 2008

(51) Int. Cl. A47J 37/07; F23D 14/28; F23N 1/00; F16K 31/44

(52) U.S. Cl. 126/39 E; 138/45; 251/213

(57) ABSTRACT

A gas-supply regulating device for use in a gas burner assembly, includes a housing defining a first delivery port communicated with a first burner tube, a second delivery port extending radially, and a gas inlet extending radially, a valve member rotatably disposed within the housing and provided with a duct unit such that rotation of the valve member results in shifting of gas supply of the gas inlet to different modes, and an actuator operable to rotate the valve member and to be shiftable between retained and released positions. Thus, the size of flames from the first and/or second burner tubes can be adjusted to meet the user's requirement during barbecuing.

### BACKGROUND OF THE INVENTION

1. Field of the Invention

This invention relates to a gas burner assembly, more particularly to a gas-supply regulating device for use in a gas burner assembly.

2. Description of the Related Art

Barbecued food has a special flavor and is therefore quite popular. However, the traditional use of wood or charcoal in barbecuing produces a lot of smoke, which is detrimental to the environment. In addition, charred food contains carcinogenic substances. Due to promotion of environmental protection and healthy lifestyles, the use of charcoal has been gradually replaced by the use of propane gas (or natural gas) in preparing barbecued food.

Generally, during the process of barbecuing, a small fire is used to broil the food till it is nearly done. Then a large fire is used to instantly heat the surface of the food so that it turns golden brown. However, with a conventional gas grill, since a gas control valve thereof is generally provided with only one gas outlet, the size of the flame is not readily adjustable to provide a large flame when desired.

### SUMMARY OF THE INVENTION

The object of the present invention is to provide a gas-supply regulating device for use in a gas burner assembly, which can regulate the amount of gas supplied to burner outlet ports so as to adjust the size of the flame.

According to this invention, the gas-supply regulating device is for use in a gas burner assembly which includes a first elongated burner tube that has a plurality of first burner outlet ports and a first intake port disposed upstream of the first burner outlet ports, and a second elongated burner tube that has a plurality of second burner outlet ports and a second intake port disposed upstream of the second burner outlet ports. The gas-supply regulating device comprises a housing, a valve member, a positioning member, and an actuator.

The housing includes an inner tubular wall surface extending along an axis to define an accommodation chamber, and terminating at rear and front inner peripheral ends which respectively define a first delivery port that is adapted to be communicated with the first intake port, and an insertion bore. A second delivery port extends radially, is communicated with the accommodation chamber, and is disposed proximate to the first delivery port. A gas inlet extends radially, is communicated with the accommodation chamber, and is disposed upstream of the first and second delivery ports for supplying gas.

The valve member includes a valve body and an actuated coupler. The valve body is elongated along the axis, is fitted in the accommodation chamber, and is rotatable relative to the accommodation chamber about the axis. The valve body is provided with a duct unit, which is configured such that, when the valve body is turned about the axis from a first position to a second position, gas supply of the gas inlet is switched from a first mode, in which the gas inlet is in fluid communication with at least the first delivery port to a second mode, in which the gas inlet is in fluid communication with at least the second delivery port. The actuated coupler is opposite to the valve body along the axis.

The positioning member is secured to the housing, and is configured to guard against axial displacement of the valve body. The positioning member includes a rear end wall confronting the actuated coupler, and a front end wall which is opposite to the rear end wall along the axis and which has an axial hole.

The actuator extends through the axial hole, and is rotatable about the axis relative to the positioning member. The actuator includes an operating end and an actuating end which is in splined engagement with the actuated coupler such that the actuated coupler is turnable with the actuating end about the axis between first and second loci which correspond to the first and second positions, respectively, and such that the actuating end is shiftable along the axis between a retained position, where the actuating end is retained in a selected one of the first and second loci and is remote from the valve body, and a released position, where the actuating end is closer to the valve body.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of the preferred embodiment of a gas-supply regulating device for use in a gas burner assembly according to this invention;

FIG. 2 is an exploded perspective view of the preferred embodiment of the gas-supply regulating device according to this invention;

FIG. 3 is a perspective view of the preferred embodiment, showing a positioning member and an actuator;

FIG. 4 is a schematic top view of a valve member of the preferred embodiment;

FIG. 5 is a sectional view taken along lines V-V of FIG. 4, and showing the valve member in a switch-off position;

FIG. 6 is a sectional view similar to FIG. 5, showing the actuator in a released position; and

FIGS. 7 to 9 are sectional views similar to FIG. 5, showing the valve member in different position for different modes of gas supply.

### DETAILED DESCRIPTION OF THE PREFERRED EMBODIMENT

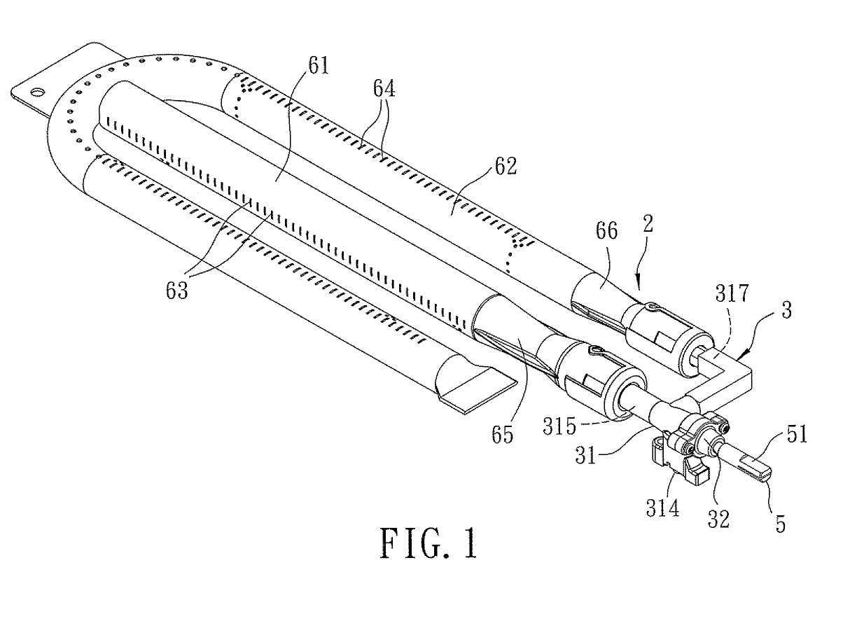

Referring to FIG. 1, the preferred embodiment of a gas-supply regulating device according to the present invention is adapted to connect with a gas source (not shown), and is used in a gas burner assembly 2 which includes first and second elongated burner tubes 61,62. The first elongated burner tube 61 has a plurality of first burner outlet ports 63 and a first intake port 65 disposed upstream of the first burner outlet ports 63. The second elongated burner tube 62 has a plurality of second burner outlet ports 64 and a second intake port 66 disposed upstream of the second burner outlet ports 64. The gas-supply regulating device according to this embodiment is shown to comprise a seat 3, a valve member 4, and an actuator 5. The seat 3 includes a housing 31 and a positioning member 32.

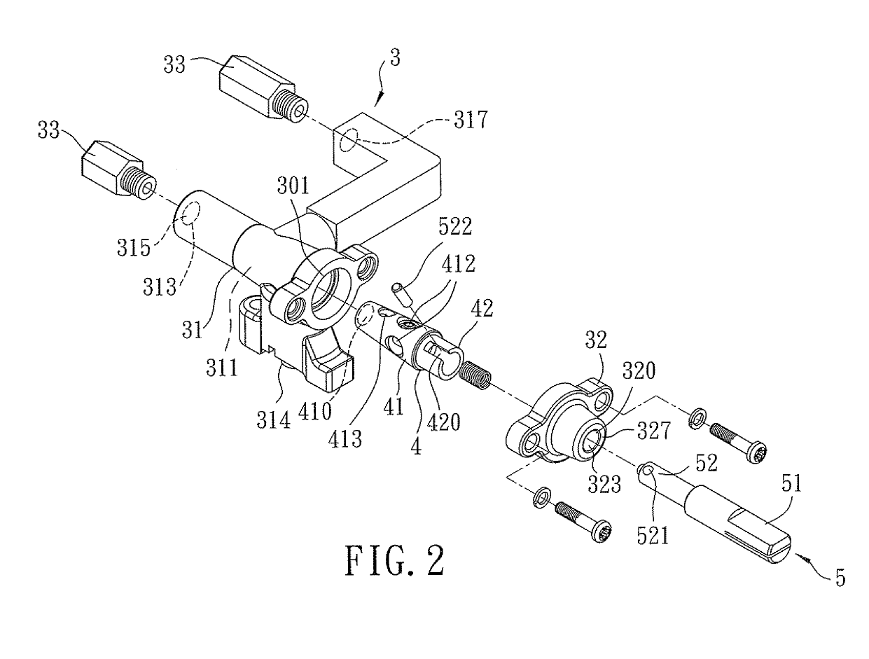

Referring to FIGS. 2, 3 and 5, the housing 31 includes an inner tubular wall surface 311 extending along an axis to define an accommodation chamber 30, and terminating at rear and front inner peripheral ends 313,316 which define a first delivery port 315 and an insertion bore 301, respectively. A first nozzle 33 is fitted to the first delivery port 315, and is coupled with the first intake port 65 so as to communicate the first delivery port 315 with the first elongated burner tube 61. A second delivery port 317 is configured to extend radially, is communicated with the accommodation chamber 30, and is disposed proximate to the first delivery port 315. A second nozzle 33 is fitted to the second delivery port 317, and is coupled with the second intake port 66 so as to communicate the second delivery port 317 with the second elongated burner tube 62. A gas inlet 314 is configured to extend radially, is communicated with the accommodation chamber 30, and is disposed upstream of the first and second delivery ports 315,317 to be connected with a gas source for supplying gas.

The valve member 4 includes a valve body 41 and an actuated coupler 42 opposite to the valve body 41 along the axis. The valve body 41 is elongated along the axis, is fitted in the accommodation chamber 30, and is rotatable relative to the accommodation chamber 30 about the axis. The valve body 41 is provided with a duct unit which includes an internal duct 410 provided in the valve body 41 and extending along the axis to be communicated with the first delivery port 315, a plurality of first internal ports 412 which are angularly displaced from one another about the axis, which respectively extend radially to be communicated with the internal duct 410, and which are disposed proximate to the gas inlet 314, and a second internal port 413 which extends radially to be communicated with the internal duct 410 and which is disposed distal from the gas inlet 314. The first internal ports 412 are of different dimensions. The actuated coupler 42 has a guide slot 420 extending axially.

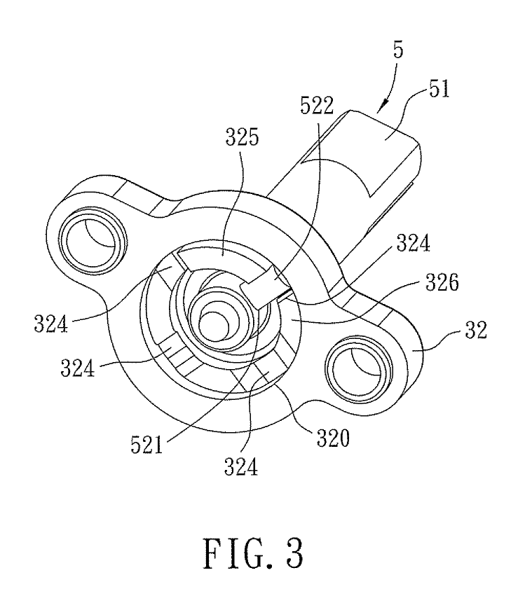

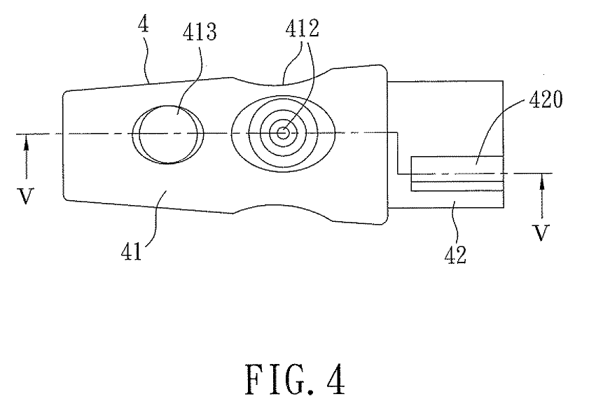

The positioning member 32 is secured to the housing 31, and is configured to guard against axial displacement of the valve body 41. The positioning member 32 includes a rear end wall 326 which confronts the actuated coupler 42, and a front end wall 327 which is opposite to the rear end wall 326 along the axis, and which has an axial hole 320 that extends through the rear end wall 326. As shown in FIG. 3, the positioning member 32 includes a plurality of positioning recesses 324 which are formed in the rear end wall 326 and which are angularly displaced from one another about the axis, and a guiding block 325 which extends rearwardly of the rear end wall 326 and which is inserted into the insertion bore 301 to be in frictional engagement with the front inner peripheral end 316 so as to facilitate mounting of the positioning member 32 to the housing 31.

The actuator 5 extends through the axial hole 320, and is rotatable about the axis relative to the positioning member 32. The actuator 5 includes an operating end 51 and an actuating end 52 opposite to each other along the axis. The actuating end 52 has an insert hole 521 extending radially and a protrusion 522 which is inserted into the insert hole 521 and which is slidable along the guide slot 420 so as to shift the actuating end 52 between a retained position, where the protrusion 522 is retained in a selected one of the positioning recesses 324 to guard against rotation of the actuator 5, and a released position, where the protrusion 522 is disengaged from the positioning recesses 324 such that, through engagement of the protrusion 522 with the guide slot 420, the actuated coupler 42 can be turned with the actuating end 52 about the axis. In addition, a biasing member 53, such as a biasing spring, is disposed to bias the actuating end 52 to the retained position.

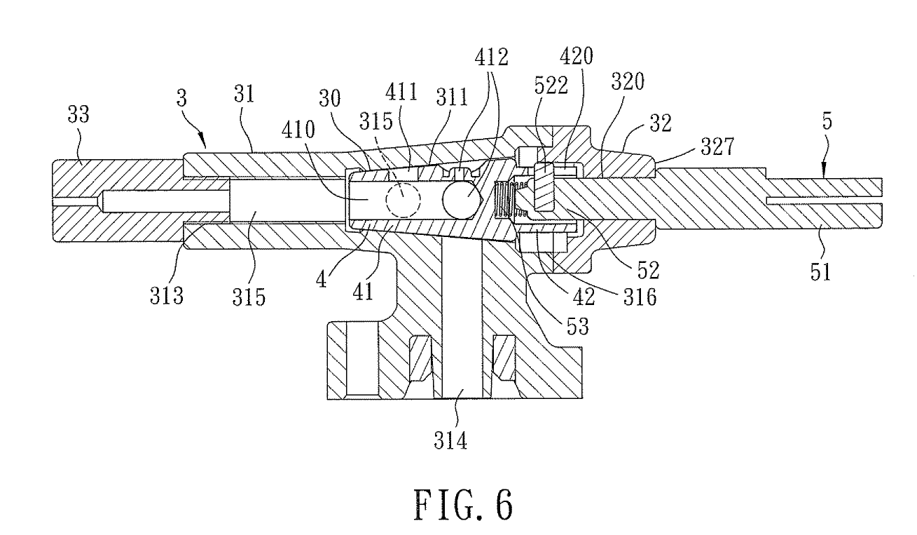

Referring to FIGS. 3, 6 and 7, when the gas burner assembly according to this embodiment is used for barbecuing, the actuator 5 is pressed rearward to the released position so as to permit disengagement of the protrusion 522 from the positioning recesses 324. Subsequently, the actuator 5 is turned such that the valve member 4 is turned until the protrusion 522 is registered with a selected one of the positioning recesses 324 so as to be retained therein by the biasing action of the biasing member 53. Thus, the valve body 41 is shifted in a switch-on position, where one of the first internal ports 412 is brought to be communicated with and to be disposed downstream of the gas inlet 314 so as to permit gas flow into the internal duct 410.

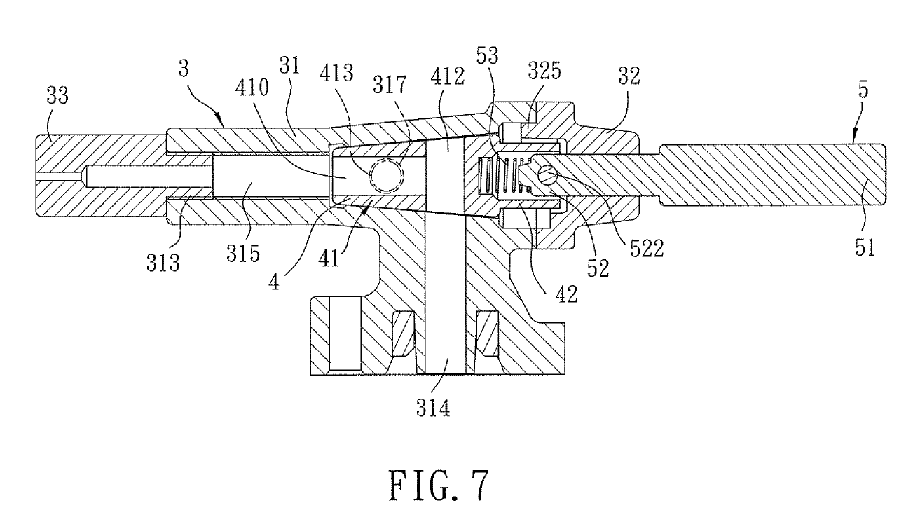

Specifically, as shown in FIGS. 1 and 7, when the valve member 4 is turned to a first position, where the second internal port 413 is not registered with the second delivery port 317, and when the first internal port 412 of a larger inner diameter is registered and communicated with the gas inlet 314, the gas supply of the gas inlet 314 is switched to a first mode, in which a larger amount of gas can be supplied to the first elongated burner tube 61. Thus, a large flame can be produced at each of the first burner outlet ports 63.

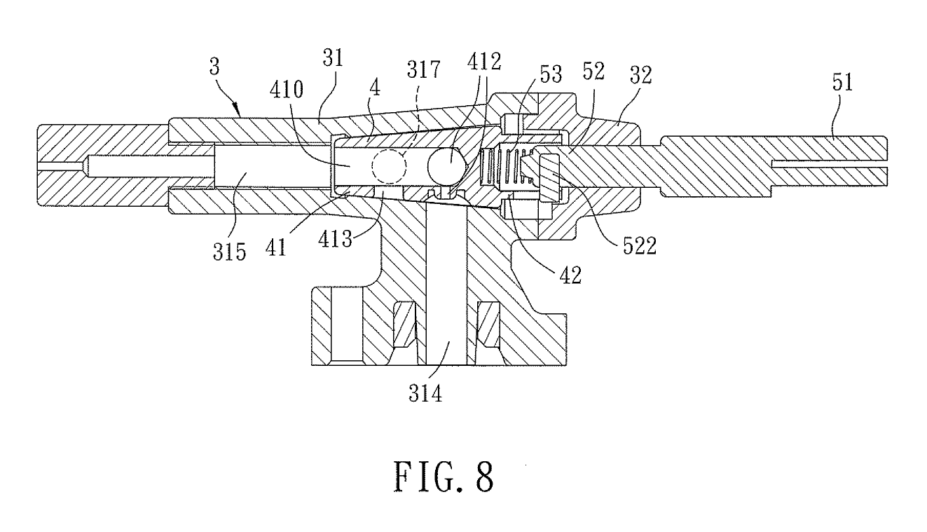

As shown in FIGS. 1 and 8, when the valve member 4 is turned such that the second internal port 413 is not registered with the second delivery port 317, and the first internal port 412, which is of a smaller inner diameter, is registered and communicated with the gas inlet 314, the gas supply of the gas inlet 314 is switched to the mode in which a smaller amount of gas can be supplied to the first elongated burner tube 61. Thus, a small flame can be produced at each of the first burner outlet ports 63.

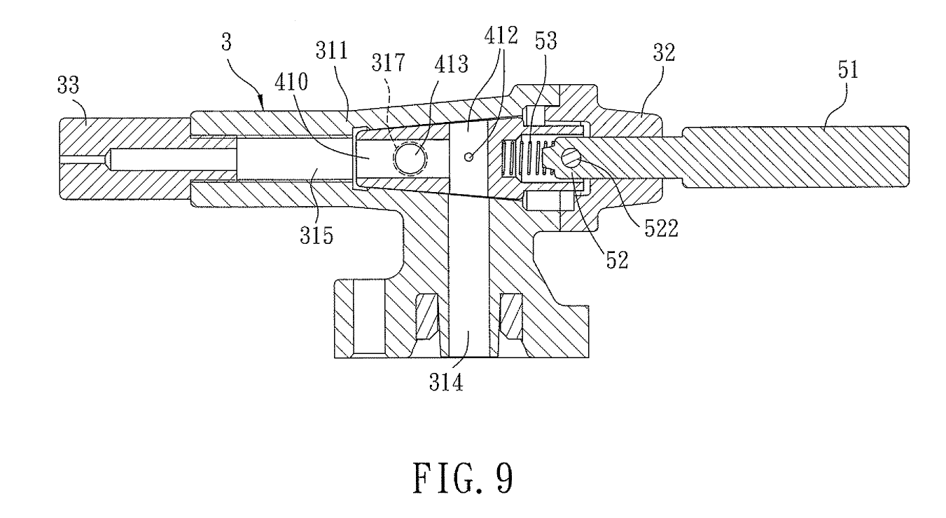

As shown in FIGS. 1 and 9, when the valve member 4 is turned to a second position, where the second internal port 413 is registered with the second delivery port 317, and when the first internal port 412, which is of a larger inner diameter, is registered and communicated with the gas inlet 314, the gas supply of the gas inlet 314 is switched to a second mode, in which a larger amount of gas can be supplied to the first and second elongated burner tubes 61,62. Thus, a large flame can be produced at each of the first and second burner outlet ports 63,64.

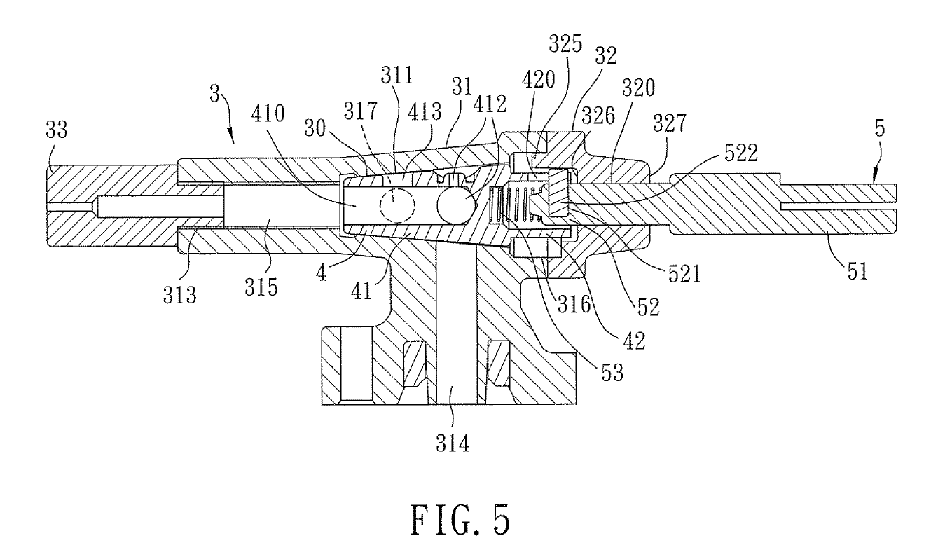

As shown in FIG. 5, when the valve member 4 is shifted to a switch-off position, none of the first internal ports 412 is registered with the gas inlet 314 such that the gas supply of the gas inlet 314 is switched to a third mode, in which no gas is supplied to the valve member 4.

It is noted that the guiding block 325 is disposed to abut against the protrusion 522 so as to guard against a 360° rotation of the actuator 5. In addition, the number of the first and second internal ports 412,413 may be varied such that the numbers of modes of the gas supply of the gas inlet 314 may be different from those described hereinabove.

As illustrated, by virtue of rotation of the actuator 5, the gas supply of the gas inlet 314 can be switched to different modes so that the size of flames can be adjusted to meet the user's requirement.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A gas-supply regulating device for use in a gas burner assembly which includes a first elongated burner tube that has a plurality of first burner outlet ports and a first intake port disposed upstream of the first burner outlet ports, and a second elongated burner tube that has a plurality of second burner outlet ports and a second intake port disposed upstream of the second burner outlet ports, said gas-supply regulating device comprising:
a housing including
an inner tubular wall surface extending along an axis to define an accommodation chamber, and terminating at rear and front inner peripheral ends which respectively define a first delivery port that is adapted to be communicated with the first intake port, and an insertion bore;
a second delivery port configured to extend radially, communicated with said accommodation chamber, and disposed proximate to said first delivery port, and
a gas inlet configured to extend radially, communicated with said accommodation chamber, and disposed upstream of said first and second delivery ports for supplying gas;
a valve member including
a valve body which is elongated along the axis, which is fitted in said accommodation chamber, and which is rotatable relative to said accommodation chamber about the axis, said valve body being provided with a duct unit, which is configured such that, when said valve body is turned about the axis from a first position to a second position, gas supply of said gas inlet is switched from a first mode, in which said gas inlet is in fluid communication with at least said first delivery port to a second mode, in which said gas inlet is in fluid communication with at least said second delivery port, and
an actuated coupler which is opposite to said valve body along the axis;
a positioning member which is secured to said housing, and which is configured to guard against axial displacement of said valve body, said positioning member including a rear end wall which confronts said actuated coupler, and a front end wall which is opposite to said rear end wall along the axis, and which has an axial hole that extends through said rear end wall; and
an actuator which extends through said axial hole, and which is rotatable about the axis relative to said positioning member, said actuator including an operating end and an actuating end which is opposite to said operating end along the axis, and which is configured to be in splined engagement with said actuated coupler such that said actuated coupler is turnable with said actuating end about the axis between first and second loci which correspond to the first and second positions, respectively, and such that said actuating end is shiftable along the axis between a retained position, where said actuating end is retained in a selected one of said first and second loci and is remote from said valve body, and a released position, where said actuating end is closer to said valve body.

2. The gas-supply regulating device according to claim 1, wherein said duct unit includes
an internal duct provided in said valve body and extending along the axis to be communicated with said first delivery port,
a plurality of first internal ports which are angularly displaced from one another about the axis, which respectively extend radially to be communicated with said internal duct, and which are disposed proximate to said gas inlet such that, in a switch-on position, one of said first internal ports is brought to be communicated with and to be disposed downstream of said gas inlet by virtue of rotation of said valve body so as to permit flowing of gas into said internal duct, and
a second internal port which extends radially to be communicated with said internal duct, and which is disposed distal from said gas inlet such that said second internal port is brought into registration with said second delivery port when said valve body is in the second position, and is brought out of registration with said second delivery port when said valve body is in the first position.

3. The gas-supply regulating device according to claim 2, wherein said first internal ports are of different dimensions.

4. The gas-supply regulating device according to claim 3, wherein none of said first internal ports is registered with said gas inlet when gas supply of said gas inlet is switched to a third mode, where said valve body is in a switch-off position.

5. The gas-supply regulating device according to claim 1, wherein said positioning member includes a plurality of positioning recesses which are formed in said rear end wall and which are angularly displaced from one another about the axis, said actuating end having a protrusion which extends radially and which is configured to mate with each one of said positioning recesses so as to place said actuating end in the retained position once said valve body is turned to a selected one of the first and second positions.

6. The gas-supply regulating device according to claim 5, wherein said actuated coupler has a guide slot which extends axially and which is disposed such that said protrusion is slidable along said guide slot so as to shift said actuating end between the retained and released positions.

7. The gas-supply regulating device according to claim 6, wherein said positioning member has a guiding block which extends rearwardly of said rear end wall and which is inserted into said insertion bore to be in frictional engagement with said front inner peripheral end so as to facilitate mounting of said positioning member to said housing, said guiding block being disposed to abut against said protrusion so as to guard against a 360° rotation of said actuator.

8. The gas-supply regulating device according to claim 1, further comprising a biasing member disposed to bias said actuating end to the retained position.

9. The gas-supply regulating device according to claim 1, further comprising first and second nozzles which are fitted to said first and second delivery ports respectively, and which are adapted to be coupled with the first and second intake ports, respectively.

10. A gas burner assembly comprising:
a first elongated burner tube which has a plurality of first burner outlet ports and a first intake port disposed respectively upstream of said first burner outlet ports;
a second elongated burner tube which has a plurality of second burner outlet ports and a second intake port disposed respectively upstream of said second burner outlet ports;
a housing including
an inner tubular wall surface extending along an axis to define an accommodation chamber, and terminating at rear and front inner peripheral ends which respectively define a first delivery port that is adapted to be communicated with the first intake port, and an insertion bore;
a second delivery port configured to extend radially, communicated with said accommodation chamber, and disposed proximate to said first delivery port, and
a gas inlet configured to extend radially, communicated with said accommodation chamber, and disposed upstream of said first and second delivery ports for supplying gas;
a valve member including
a valve body which is elongated along the axis, which is fitted in said accommodation chamber, and which is rotatable relative to said accommodation chamber about the axis, said valve body being provided with a duct unit which is configured such that, when said valve body is turned about the axis from a first position to a second position, gas supply of said gas inlet is switched from a first mode, in which said gas inlet is in fluid communication with at least said first delivery port to a second mode, in which said gas inlet is in fluid communication with at least said second delivery port, and
an actuated coupler which is opposite to said valve body along the axis;
a positioning member which is secured to said housing, and which is configured to guard against axial displacement of said valve body, said positioning member including a rear end wall which confronts said actuated coupler, and a front end wall which is opposite to said rear end wall along the axis, and which has an axial hole that extends through said rear end wall; and
an actuator which extends through said axial hole, and which is rotatable about the axis relative to said positioning member, said actuator including an operating end, and an actuating end which is opposite to said operating end along the axis, and which is configured to be in splined engagement with said actuated coupler such that said actuated coupler is turnable with said actuating end about the axis between first and second loci which correspond to the first and second positions, respectively, and such that said actuating end is shiftable along the axis between a retained position, where said actuating end is retained in a selected one of said first and second loci and is remote from said valve body, and a released position, where said actuating end is closer to said valve body.
